(19) United States
(12) Patent Application Publication
(10) Pub. No.: US 2005/0072849 A1
(43) Pub. Date: Apr. 7, 2005

(54) Identification document with optical memory and related method of manufacture

(76) Inventor: Robert L. Jones, Andover, MA (US)

Correspondence Address: DIGIMARC CORPORATION, 9405 SW GEMINI DRIVE, BEAVERTON, OR, 97008, US

(21) Appl. No.: 10/933,818

(22) Filed: Sep. 3, 2004

Related U.S. Application Data
(60) Provisional application No. 60/500,204, filed on Sep. 3, 2003.

(51) Int. Cl. G06K 19/00; G06K 5/00

(52) U.S. Cl. 235/487; 235/380

(57) ABSTRACT

This disclosure describes an identification document with optical recording media, as well as related methods for making identification documents and materials used to make identification documents. The identification document includes first and second layers. The second layer is cut to form wells for receiving patches of the optical recording media. The first and second layers are joined, and the patches are placed into the wells. The first and second layers and patches form a composite structure that is used to make identification documents. In particular, in one embodiment, the patches are placed into the wells, which are filled with a curable liquid. The composite laminate structure is then joined with a core layer. Other layers may be added, such as a laminate on the opposite side of the core from the composite laminate, and image receiving layers for printing variable information.

### RELATED APPLICATION DATA

This application claims benefit of U.S. patent application 60/500,204, filed Sep. 3, 2003, which is hereby incorporated by reference, and is related to the following U.S. patent applications:

Publications 2003/0038174 and 2003/0178495 describing the use of smart cards in identification documents. The optical media described in this document can be used to provide functions of smart cards, such as the functions described in these patent documents.

60/471,429 describing a type of identification document that may be constructed with an optical memory device as described in this document.

Publication 2003/0234286 describing laser engraving, which may be used in some embodiments to print fixed and variable data on identification documents.

Publication 2003/0173406 describing how to apply UV and other security features in identification documents, which may be used in embodiments of the invention.

Publication 2003/0183695 describing how to manufacture identification documents in a central issue process, which may be used to make embodiments of the invention.

60/495,373 describing how to incorporate and use a variety of security features, such as machine readable memory like the optical media in this document, into identification documents.

Each of the above U.S. Patent documents is herein incorporated by reference in its entirety.

### TECHNICAL FIELD

The invention generally relates to identification and security documents, and in particular, relates to a document structure and a method of making the document structure with an optical memory device.

### BACKGROUND AND SUMMARY

Identification Documents

There is an ever-present demand to enhance the security and functionality of identification documents, while maximizing their durability and minimizing their cost. One way to enhance there security and functionality is to incorporate machine readable elements, such as bar codes, smart cards, contact and contactless integrated circuits, RFID devices, optical media, magnetic media, digital watermarks, holograms, etc.

One particular machine readable feature for such documents is an optical memory device, such as the optical memory card from LaserCard Systems Corp. of Mountain View, Calif. The cost and design requirements of certain identification document applications pose a challenge for integrators attempting to incorporate these types of memory devices in existing card production environments. In particular, large identification document programs, such as driver's license programs, demand high durability and high volume production at reasonable cost. To achieve these objectives while exploiting the functionality of the optical memory device, there is a need for methods of integrating optical memory devices in identification documents that takes advantage of existing high volume and high durability document production environments without interfering with existing quality, security features and document design requirements. To highlight this challenge, the following sections begin with a background describing identification documents and methods of producing them.

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening and prior to boarding their flight. In addition, because we live in an ever-evolving cashless society, ID documents are used to make payments, access an automated teller machine (ATM), debit an account, or make a payment, etc.

(For the purposes of this disclosure, ID documents are broadly defined herein, and include, e.g., credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge” and “documentation” are used interchangeably throughout this patent application.).

Many types of identification cards and documents, such as driving licenses, national or government identification cards, bank cards, credit cards, controlled access cards and smart cards, carry certain items of information which relate to the identity of the bearer. Examples of such information include name, address, birth date, signature and photographic image; the cards or documents may in addition carry other variable data (i.e., data specific to a particular card or document, for example an employee number) and invariant data (i.e., data common to a large number of cards, for example the name of an employer). All of the cards described above will be generically referred to as “ID documents”.

As those skilled in the art know, ID documents such as drivers licenses can contain information such as a photographic image, a bar code (which may contain information specific to the person whose image appears in the photographic image, and/or information that is the same from ID document to ID document), variable personal information, such as an address, signature, and/or birthdate, biometric information associated with the person whose image appears in the photographic image (e.g., a fingerprint, a facial image or template, or iris or retinal template), a magnetic stripe (which, for example, can be on the a side of the ID document that is opposite the side with the photographic image), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

An exemplary ID document can comprise a core layer (which can be pre-printed), such as a light-colored, opaque material (e.g., TESLIN (available from PPG Industries) or polyvinyl chloride (PVC) material). The core is laminated with a transparent material, such as clear PVC to form a so-called “card blank”. Information, such as variable personal information (e.g., photographic information), is printed on the card blank using a method such as Dye Diffusion Thermal Transfer (“D2T2”) printing (described further below and also described in commonly assigned U.S. Pat. No. 6,066,594, which is incorporated herein by reference in its entirety.) The information can, for example, comprise an indicium or indicia, such as the invariant or nonvarying information common to a large number of identification documents, for example the name and logo of the organization issuing the documents. The information may be formed by any known process capable of forming the indicium on the specific core material used.

To protect the information that is printed, an additional layer of transparent overlaminate can be coupled to the card blank and printed information, as is known by those skilled in the art. Illustrative examples of usable materials for overlaminates include biaxially oriented polyester or other optically clear durable plastic film.

In the production of images useful in the field of identification documentation, it may be desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

Identification documents, such as ID cards, having printed background security patterns, designs or logos and identification data personal to the card bearer have been known and are described, for example, in U.S. Pat. No. 3,758,970, issued Sep. 18, 1973 to M. Annenberg; in Great Britain Pat. No. 1,472,581, issued to G. A. O. Gesellschaft Fur Automation Und Organisation mbH, published Mar. 10, 1976; in International Patent Application PCT/GB82/00150, published Nov. 25, 1982 as Publication No. WO 82/04149; in U.S. Pat. No. 4,653,775, issued Mar. 31, 1987 to T. Raphael, et al.; in U.S. Pat. No. 4,738,949, issued Apr. 19, 1988 to G. S. Sethi, et al.; and in U.S. Pat. No. 5,261,987, issued Nov. 16, 1993 to J. W. Luening, et al. All of the aforementioned documents are hereby incorporated by reference.

Printing Information onto ID Documents

The advent of commercial apparatus (printers) for producing dye images by thermal transfer has made relatively commonplace the production of color prints from electronic data acquired by a video camera. In general, this is accomplished by the acquisition of digital image information (electronic signals) representative of the red, green and blue content of an original, using color filters or other known means. Devices such as digital cameras, optical sensors, and scanners also can provide digital image information. The digital image information is utilized to print an image onto a data carrier. For example, information can be printed using a printer having a plurality of small heating elements (e.g., pins) for imagewise heating of each of a series of donor sheets (respectively, carrying diffuseable cyan, magenta and yellow dye). The donor sheets are brought into contact with an image-receiving element (which can, for example, be a substrate), which has a layer for receiving the dyes transferred imagewise from the donor sheets. Thermal dye transfer methods are described, for example, in U.S. Pat. No. 4,621,271, issued Nov. 4, 1986 to S. Brownstein and U.S. Pat. No. 5,024,989, issued Jun. 18, 1991 to Y. H. Chiang, et al. Each of these patents is hereby incorporated by reference.

Dye diffusion thermal transfer printing (“D2T2”) and thermal transfer (also referred to as mass transfer printing) are two printing techniques that have been used to print information on identification cards. For example, D2T2 has been used to print images and pictures, and thermal transfer has been used to print text, bar codes, and single color graphics.

D2T2 is a thermal imaging technology that allows for the production of photographic quality images. In D2T2 printing, one or more thermally transferable dyes (e.g., cyan, yellow, and magenta) are transferred from a donor, such as a donor dye sheet or a set of panels (or ribbons) that are coated with a dye (e.g., cyan, magenta, yellow, black, etc.) to a receiver sheet (which could, for example, be part of an ID document) by the localized application of heat or pressure, via a stylus or thermal printhead at a discrete point. When the dyes are transferred to the receiver, the dyes diffuse into the sheet (or ID card substrate), where the dyes will chemically be bound to the substrate or, if provided, to a receptor coating. Typically, printing with successive color panels across the document creates an image in or on the document's surface. D2T2 can result in a very high printing quality, especially because the energy applied to the thermal printhead can vary to vary the dye density in the image pixels formed on the receiver, to produce a continuous tone image. D2T2 can have an increased cost as compared to other methods, however, because of the special dyes needed and the cost of D2T2 ribbons. Also, the quality of D2T2-printed image may depend at least on an ability of a mechanical printer system to accurately spatially register a printing sequence, e.g., yellow, magenta, cyan, and black.

Another thermal imaging technology is thermal or mass transfer printing. With mass transfer printing, a material to be deposited on a receiver (such as carbon black (referred to by the symbol “K”)) is provided on a mass transfer donor medium. When localized heat is applied to the mass transfer donor medium, a portion (mass) of the material is physically transferred to the receiver, where it sits “on top of” the receiver. For example, mass transfer printing often is used to print text, bar codes, and monochrome images. Resin black mass transfer has been used to print grayscale pictures using a dithered gray scale, although the image can sometimes look coarser than an image produced using D2T2. However, mass transfer printing can sometimes be faster than D2T2, and faster printing can be desirable in some situations.

Printing of black (“K”) can be accomplished using either D2T2 or mass transfer. For example, black monochrome “K” mass transfer ribbons include Kr (which designates a thermal transfer ribbon) and Kd (which designates dye diffusion).

Both D2T2 and thermal ink have been combined in a single ribbon, which is the well-known YMCK (Yellow-Magenta-Cyan-Black) ribbon (the letter “K” is used to designate the color black in the printing industry). Another panel containing a protectant (“P”) or laminate (typically a clear panel) also can be added to the YMCK ribbon).

In addition to these forms of printing, other forms of printing and applying variable data are used in ID documents, including ink jet printing, laser printing and laser engraving.

Manufacture and Printing Environments

Commercial systems for issuing ID documents are of two main types, namely so-called “central” issue (CI), and so-called “on-the-spot” or “over-the-counter” (OTC) issue.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

In contrast, a CI assembling process is more of a bulk process facility, where many cards are produced in a centralized facility, one after another. (For example, picture a setting where a driver passes a driving test, but then receives her license in the mail from a CI facility a short time later. The CI facility may process thousands of cards in a continuous manner.).

Centrally issued identification documents can be produced from digitally stored information and generally comprise an opaque core material (also referred to as “substrate”), such as paper or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents.

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents are manufactured.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document. It will be appreciated that an OTC card issuing process is by its nature can be an intermittent—in comparison to a continuous—process.

OTC identification documents of the types mentioned above can take a number of forms, depending on cost and desired features. Some OTC ID documents comprise highly plasticized poly(vinyl chloride) or have a composite structure with polyester laminated to 0.5-2.0 mil (13-51 .mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the printhead, holographic hot stamp foils (0.125-0.250 mil 3-6 .mu.m), or a clear polyester laminate (0.5-10 mil, 13-254 .mu.m) supporting common security features. These last two types of protective foil or laminate sometimes are applied at a laminating station separate from the printhead. The choice of laminate dictates the degree of durability and security imparted to the system in protecting the image and other data.

### SUMMARY

The invention provides an identification document with optical recording media, as well as related methods for making identification documents and materials used to make identification documents. The identification document includes first and second layers. The second layer is cut to form wells for receiving patches of the optical recording media. The first and second layers are joined, and the patches are placed into the wells. The first and second layers and patches form a composite structure that is used to make identification documents. In particular, in one embodiment, the patches are placed into the wells, which are filled with a curable liquid. The composite laminate structure is then joined with a core layer. Other layers may be added, such as a laminate on the opposite side of the core from the composite laminate, and image receiving layers for printing variable information.

The foregoing and other features and advantages of the present invention will be even more readily apparent from the following Detailed Description, which proceeds with reference to the accompanying drawings and the claims.

### BRIEF DESCRIPTION OF THE DRAWINGS

The advantages, features, and aspects of embodiments of the invention will be more fully understood in conjunction with the following detailed description and accompanying drawings, wherein:

FIG. 1 illustrates an exploded isometric view of an example of an identification document with an optical memory device;

FIG. 2 illustrates a cross sectional view of the identification document of FIG. 1;

FIG. 3 is a flow diagram illustrating a method of making the identification document of FIG. 1.

Of course, the drawings are not necessarily drawn to scale, with emphasis rather being placed upon illustrating the principles of the invention. In the drawings, like reference numbers indicate like elements or steps. Further, throughout this application, certain indicia, information, identification documents, data, etc., may be shown as having a particular cross sectional shape (e.g., rectangular) but that is provided by way of example and illustration only and is not limiting, nor is the shape intended to represent the actual resultant cross sectional shape that occurs during manufacturing of identification documents.

### DETAILED DESCRIPTION

Terminology

In the foregoing discussion, the use of the word “ID document” is broadly defined and intended to include all types of ID documents, including (but not limited to), documents, magnetic disks, credit cards, bank cards, phone cards, stored value cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver's licenses, network access cards, employee badges, debit cards, security cards, visas, immigration documentation, national ID cards, citizenship cards, social security cards, security badges, certificates, identification cards or documents, voter registration and/or identification cards, police ID cards, border crossing cards, security clearance badges and cards, legal instruments, gun permits, badges, gift certificates or cards, membership cards or badges, and tags. Also, the terms “document,” “card,” “badge” and “documentation” are used interchangeably throughout this patent application.). In at least some aspects of the invention, ID document can include any item of value (e.g., currency, bank notes, and checks) where authenticity of the item is important and/or where counterfeiting or fraud is an issue.

In addition, in the foregoing discussion, “identification” at least refers to the use of an ID document to provide identification and/or authentication of a user and/or the ID document itself. For example, in a conventional driver's license, one or more portrait images on the card are intended to show a likeness of the authorized holder of the card. For purposes of identification, at least one portrait on the card (regardless of whether or not the portrait is visible to a human eye without appropriate stimulation) preferably shows an “identification quality” likeness of the holder such that someone viewing the card can determine with reasonable confidence whether the holder of the card actually is the person whose image is on the card. “Identification quality” images, in at least one embodiment of the invention, include covert images that, when viewed using the proper facilitator (e.g., an appropriate light or temperature source), provide a discernable image that is usable for identification or authentication purposes.

There are a number of reasons why an image or information on an ID document might not qualify as an “identification quality” image. Images that are not “identification quality” may be too faint, blurry, coarse, small, etc., to be able to be discernable enough to serve an identification purpose. An image that might not be sufficient as an “identification quality” image, at least in some environments, could, for example, be an image that consists of a mere silhouette of a person, or an outline that does not reveal what might be considered essential identification essential (e.g. hair or eye color) of an individual.

Of course, it is appreciated that certain images may be considered to be “identification quality” if the images are machine readable or recognizable, even if such images do not appear to be “identification quality” to a human eye, whether or not the human eye is assisted by a particular piece of equipment, such as a special light source. For example, in at least one embodiment of the invention, an image or data on an ID document can be considered to be “identification quality” if it has embedded in it machine-readable information (such as digital watermarks or steganographic information) that also facilitate identification and/or authentication.

Further, in at least some embodiments, “identification” and “authentication” are intended to include (in addition to the conventional meanings of these words), functions such as recognition, information, decoration, and any other purpose for which an indicia can be placed upon an article in the article's raw, partially prepared, or final state. Also, instead of ID documents, the inventive techniques can be employed with product tags, product packaging, business cards, bags, charts, maps, labels, etc., etc., particularly those items including marking of an laminate or over-laminate structure. The term ID document thus is broadly defined herein to include these tags, labels, packaging, cards, etc.

“Personalization”, “Personalized data” and “variable” data are used interchangeably herein, and refer at least to data, images, and information that are “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as birthdate, height, weight, eye color, address, etc., that are personal to a specific cardholder but not necessarily unique to that cardholder (for example, other cardholders might share the same personal data, such as birthdate). In at least some embodiments of the invention, personal/variable data can include some fixed data, as well. For example, in at least some embodiments, personalized data refers to any data that is not pre-printed onto an ID document in advance, so such personalized data can include both data that is cardholder-specific and data that is common to many cardholders. Variable data can, for example, be printed on an information-bearing layer of the ID card using thermal printing ribbons and thermal printheads.

The terms “indicium” and indicia as used herein cover not only markings suitable for human reading, but also markings intended for machine reading. Especially when intended for machine reading, such an indicium need not be visible to the human eye, but may be in the form of a marking visible only under infra-red, ultra-violet or other non-visible radiation. Thus, in at least some embodiments of the invention, an indicium formed on any layer in an identification document (e.g., the core layer) may be partially or wholly in the form of a marking visible only under non-visible radiation. Markings comprising, for example, a visible “dummy” image superposed over a non-visible “real” image intended to be machine read may also be used.

“Laminate” and “overlaminate” include (but are not limited to) film and sheet products. Laminates usable with at least some embodiments of the invention include those which contain substantially transparent polymers and/or substantially transparent adhesives, or which have substantially transparent polymers and/or substantially transparent adhesives as a part of their structure, e.g., as an extruded feature. Examples of usable laminates include at least polyester, polycarbonate, polystyrene, cellulose ester, polyolefin, polysulfone, or polyamide. Laminates can be made using either an amorphous or biaxially oriented polymer as well. The laminate can comprise a plurality of separate laminate layers, for example a boundary layer and/or a film layer.

The degree of transparency of the laminate can, for example, be dictated by the information contained within the identification document, the particular colors and/or security features used, etc. The thickness of the laminate layers is not critical, although in some embodiments it may be preferred that the thickness of a laminate layer be about 1-20 mils. Lamination of any laminate layer(s) to any other layer of material (e.g., a core layer) can be accomplished using any conventional lamination process, and such processes are well-known to those skilled in the production of articles such as identification documents. Of course, the types and structures of the laminates described herein are provided only by way of example, those skilled in the art will appreciated that many different types of laminates are usable in accordance with the invention.

For example, in ID documents, a laminate can provide a protective covering for the printed substrates and provides a level of protection against unauthorized tampering (e.g., a laminate would have to be removed to alter the printed information and then subsequently replaced after the alteration.). Various lamination processes are disclosed in assignee's U.S. Pat. Nos. 5,783,024, 6,007,660, 6,066,594, and 6,159,327. Other lamination processes are disclosed, e.g., in U.S. Pat. Nos. 6,283,188 and 6,003,581. Each of these U.S. Patents is herein incorporated by reference.

The material(s) from which a laminate is made may be transparent, but need not be. Laminates can include synthetic resin-impregnated or coated base materials composed of successive layers of material, bonded together via heat, pressure, and/or adhesive. Laminates also includes security laminates, such as a transparent laminate material with proprietary security technology features and processes, which protects documents of value from counterfeiting, data alteration, photo substitution, duplication (including color photocopying), and simulation by use of materials and technologies that are commonly available. Laminates also can include thermosetting materials, such as epoxy.

For purposes of illustration, the following description will proceed with reference to ID document structures (e.g., TESLIN-core, multi-layered ID documents) and fused polycarbonate structures. It should be appreciated, however, that the present invention is not so limited. Indeed, as those skilled in the art will appreciate, the inventive techniques can be applied to many other structures formed in many different ways. For example, in at least some embodiments, the invention is usable with virtually any product which is made to carry an optical memory device, especially articles to which a laminate and/or coating is applied, including articles formed from paper, wood, cardboard, paperboard, glass, metal, plastic, fabric, ceramic, rubber, along with many man-made materials, such as microporous materials, single phase materials, two phase materials, coated paper, synthetic paper (e.g., TYVEC, manufactured by Dupont Corp of Wilmington, Del.), foamed polypropylene film (including calcium carbonate foamed polypropylene film), plastic, polyolefin, polyester, polyethylenetelphthalate (PET), PET-G, PET-F, and polyvinyl chloride (PVC), and combinations thereof.

Identification Document with Optical Memory Device

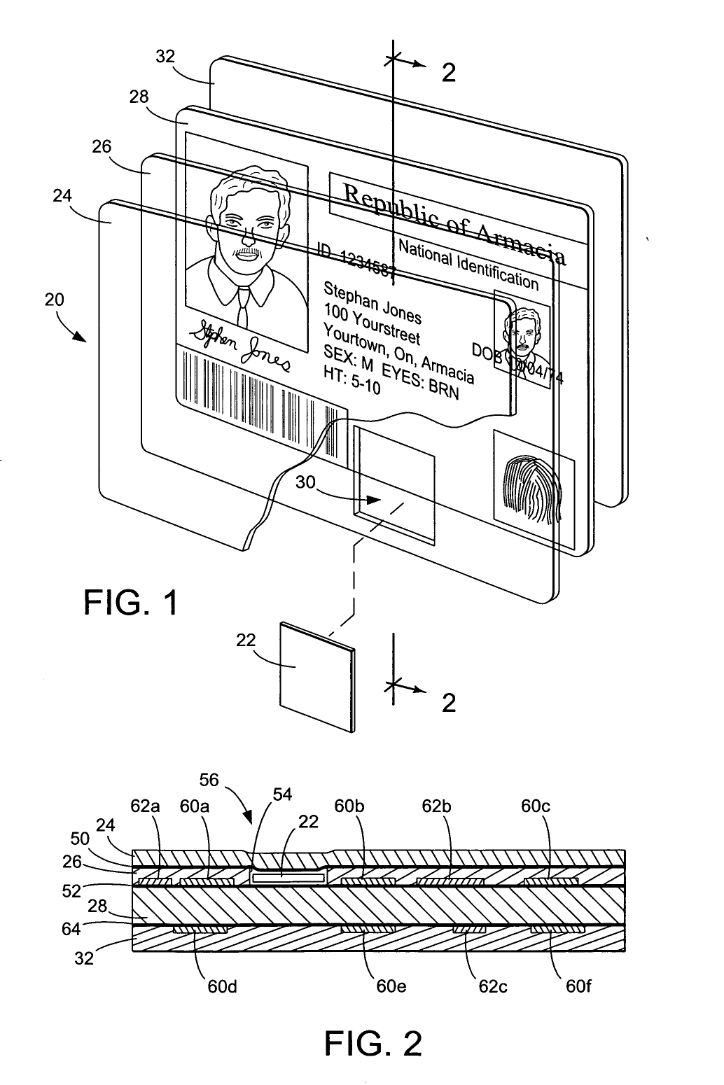

FIG. 1 illustrates an exploded isometric view of an example of an identification document 20 with an optical memory device 22. The identification document has a multi-layer structure including a first layer 24, second layer 26, and core layer 28. The second layer has a well 30 to receive the optical memory device 22. In this particular example, the first and second layers are laminate layers. They are joined to form an upper layer for the document that receives and carries the optical memory device 22. The document also has a third layer 32 that is joined to the back of the document. The third layer is another laminate layer that protects the back of the document.

Preferably, the layers in the document structure should have similar properties (e.g., have a symmetric structure). In particular, the materials should have similar coefficients of expansion/contraction so that they shrink and grow at the same rate. For example in one embodiment, the first, second and third layers are made of a polycarbonate and are bonded to a TESLIN core. Alternative materials may be used, including but not limited to polyester, styrene, vinyl, or combinations thereof.

FIG. 1 also illustrates a number of features on the document. These features include, for example, variable printed information, a facial photo, signature, bar code, identification number, personal information (name, address, date of birth, gender, hair and eye color), fingerprint, ghost image, etc. They also include fixed printed information such as an issuer identification and related design elements (e.g., “Republic of Armacia”), and a document type identifier (e.g., “National Identification”). The variable and fixed information may be printed on the same or different layers. In this particular example, both are printed on the document core or substrate (e.g., using Laser Xerography). This printing is indicative of a CI process where both variable and fixed information are available at the time of document manufacture.

In other document structures, such as those typical in OTC processes, the document is manufactured first, including any fixed information and features that are common to each document. Then, at the issuer location, variable information is received and printed on the document. This variable information may be printed onto an image receiving layer on the document, which may then be further protected by another laminate layer (e.g., an over-laminate).

FIG. 2 illustrates a cross sectional view of the identification document of FIG. 1, showing additional detail of the document structure. As explained in further detail below, the first layer 24 optionally includes a hard coated outer surface, and includes an optically clear adhesive coating 50 on the opposite side between it and the second layer. The second layer 26 is die cut to dimension that will accept with some tolerance a “patch” of optical recording media 22. In this example, the optical recording media is cut from a roll of 35 mm LASERCARD from LaserCard Systems Corp. of Mountain View, Calif. An adhesive coating 52 is also supplied with this layer on one side. The first and second layers are joined together. A curable liquid 54 is deposited into the well 30, and then the patch 22 is placed in the well. After processing the first and second layers to form a composite structure including the optical media, the resulting structure is joined to the core 28 via the adhesive coating 52 applied to the second layer 26. The specific order and nature of this processing may vary. A specific, detailed example of this process is illustrated in more detail below.

The depth of the well 30 is set relative to the thickness of the patch such that the well is not completely filled. As a result, a controlled depression 56 is created in the surface of the document in the area immediately over the patch, and this area is relative to the other surface of the document. In constructing the upper laminate in this way, the surface area through which the optical media will be written and read is protected by virtue of not lying in the same plane as the rest of the document surface. Normal surface wear and tear will largely be bypassed on this strategic area.

Any number of layers/materials may be located between the patch and the surface of the document. However, in order to allow for reading and/or writing of the patch, the document is constructed such that layers between the surface and the patch provide a clear optical path to the patch enabling optical reading and/or writing.

As noted above, fixed (60a-f) and variable (62a-c) information is printed on the front and back of the core 28. In this example, Laser Xerography is used to print both the variable and fixed information. However, this information may be printed using different printing technologies on the same or different layers, at the same or different stages of document production.

The third layer 32 is joined to the back of the core 28 via another adhesive layer 64. As explained more fully below, the composite structure of the top two layers 24, 26, the core 28 and the third layer 32 are brought together in a lamination process. The particular number, order, and method of joining the layers can vary from process to process.

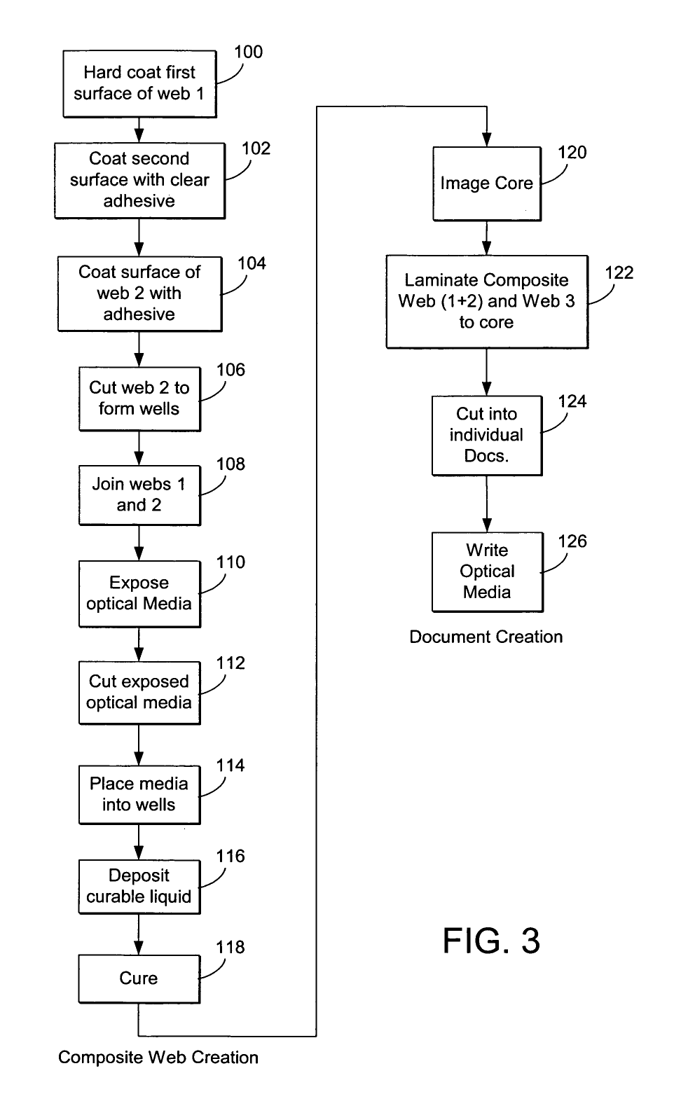

FIG. 3 is a flow diagram illustrating a method of making the identification document of FIG. 1. The process begins by constructing a composite web structure from first and second web layers with embedded optical memory devices. These web layers form the first and second layers of the document structure described previously. To illustrate this process, we use an example of the structure illustrated in FIG. 2, including first and second web layers made of a laminate material, namely polycarbonate (e.g., each 5 Mils). Polycarbonate is only one example of the type of material that may be used in a composite laminate structure. Others include polyester, co-polyester, styrenics, etc. and combinations thereof.

As shown in block 100, the process hard coats the outer surface of a first polycarbonate web by a typical UV cured acrylate technology, optionally including appropriate slip and anti-wetting ingredients. As shown in block 102, the process coats the surface on the opposite side with an adhesive formulation that will withstand all ANSI-ISO and NCITS test protocols in the resultant document structure. Examples of coating processes include solvent based coating techniques or polymeric extrusion. The surface with the adhesive forms the inner surface that is joined with the second layer in the web structure.

As shown in block 104, the process coats the surface of a second polycarbonate web with an adhesive that will ultimately function as the adhesive that joins the finished upper laminate to the core. It is then die cut to a dimension that will receive the patch of optical recording media (block 106). The depth of the well is set such that a 4 Mil “patch” plus 0.5 to 1 Mil of curable adhesive is less than the thickness of the second web. Given that the well will not be filled completely by the incorporation of the recording media, the process creates a controlled depression immediately over the patch so that this area of the card is depressed relative to all other surfaces of the document as described above.

The process then joins the first and second webs by a roll to roll lamination process of heat and temperature or (if an electron beam (EB) curing system is employed) by the application of a suitable curable EB formulation, joining of the two webs, and then by curing with EB (block 108). These first and second webs form a composite web structure.

Generally speaking, the process of joining layers in the document may be performed in alternative ways. Some examples include: using a press laminate with a thermoplastic adhesive that is either separate from the layers being joined or included with one or more of the layers; using all EB curable adhesive; and combining EB/UV curable adhesives with post curing after roll lamination. Layers can be joined by melting and fusing together. Adhesives are not required in all cases for joining layers.

The composite web structure has die cut “wells” that are positioned such that the resultant optical recording media patch will reside in the desired and fixed location in the finished document.

A roll of optical recording media that has been exposed with a “fixed” design including guide and registration positioning lines and graphics (block 110) is cut or die cut into individual patches of a dimension slightly smaller than the “wells” that have been incorporated into the upper laminate web structure (block 112). These individual “patches” are then placed into these wells by a typical “pick and place” robotic system (block 1114). A two-part epoxy or ultraviolet (UV) or EB curable liquid is deposited prior to the patches placement into the well (block 116). A sufficient amount of liquid is deposited such that all void volumes are filled with the liquid and all surfaces are wet out 100%. Once the patch has been placed into the well with the curing liquid system, the web advances into a curing station, and the optically clear adhesive is cured in place (block 118). As noted, one type of optical recording media is 35 mm fully developed LASERCARD media from LaserCard Systems, Corp.

The roll of optical recording material is processed so as to protect the recording media from physical damage in processing and shipping and in the die cutting and placement operations. One form of protection process is to coat the recording media in a separate step with an optically clear material that will provide the protection necessary. The material will then be wound and shipped in 35 mm spools to a document manufacturing location. This allows easy secure control of the inventory within facilities for creating the media and incorporating the media into documents.

Having constructed the composite web structure with optical recording media, the next phase of the process manufactures the documents. In this phase, the process combines the composite web, core and a third web forming the front, middle, and back of the document, respectively. In this particular example, the third web comprises a web composed of 7 Mils of an appropriate polycarbonate finished with 3 Mils of a suitable adhesive to bond to the core material, which is a TESLIN core. The three materials (composite web, core, and third web) come together in CI process in which the TESLIN core (usually preprinted with appropriate graphics and security features) is imaged with the document bearer's image and demographic data in sheet form (block 120). These imaged sheets of particular lot size are then fed into a heat/pressure laminating nip where the composite web and third web are brought together in a registered way and laminated to the core (block 122). The resultant web is then die cut to individual documents (block 124).

As noted previously, there are a number of alternative ways to join layers of the document together. The specific method of the previous paragraph is just one example.

These individual documents are then fed into the appropriate set of optical media writing devices where the barcodes on the DL will be read identifying the individual and the desired image and data will be written into the “patch” (block 126). The optical recording media has a large storage capacity (e.g., approximately 2.8 MB for some of the LASERCARD media). With this large capacity, the memory can be partitioned into zones and written to several times. While the LASERCARD optical recording media is write once, read only, the effect of updating the memory with new data over the life of the document can be achieved by writing new data into new, previously unused zones, and tracking in memory or externally which zones no longer have valid data. The methods of this document can also be used for optical recording media that is re-writable, such as the optical memory technology used for DVD re-writeable formats like DVD-RAM, −RW and +RW. In addition, functions performed by and data stored in other memory devices, like RFID, smart card, and/or integrated circuits, such as described in this document and the incorporated documents, can be replicated in the optical recording media.

While the CI process is mentioned specifically, a similar process can be used to create over the counter documents that are sent to over the counter locations for printing of variable data at the time of document issuance. The variable printing can be added at the issuing location, such as by using D2T2 printing on an image receiving layer that is applied over the first layer in the manufacturing process. The variable data, such as photo, fingerprint and other biometrics may be cryptographically transformed (e.g., encrypted, securely hashed, digitally signed, etc.) and stored in the optical memory for use in authenticating the other information on the document.

The optical memory device may be used to store a variety of data to enhance the security of the document and/or increase its functionality. For example, it may be used to store information related to information elsewhere on the document and/or in a database record associated with the document. Preferably, the identification document uses a layered security approach where a number of security features convey similar or mathematically related information that can be used to verify the integrity of the document through checking the relationships among data stored in machine readable security features. Other machine readable, data carrying security features include holograms, digital watermarks, bar codes, magnetic stripes, integrated circuits, smart cards, etc. Higher capacity memory elements in the document can be used to store images, audio, text and other binary data, which can be digitally watermarked and/or secured with encryption and digital signatures. More techniques for digital watermarks and ID cards can be found in Digimarc's U.S. Provisional Patent application Nos. 60/421,254 and 60/495,373, U.S. patent application Ser. No. 10/094,593, and in U.S. Pat. No. 5,841,886. Each of these patent documents is incorporated herein by reference. We expressly contemplate that the techniques disclosed in this application can be combined with the aspects of the present invention.

### CONCLUDING REMARKS

Having described and illustrated the principles of the technology with reference to specific implementations, it will be recognized that the technology can be implemented in many other, different, forms, and in many different environments.

The technology disclosed herein can be used in combination with other technologies. Also, instead of ID documents, the inventive techniques can be employed with product tags, product packaging, labels, business cards, bags, charts, smart cards, maps, labels, etc., etc. The term ID document is broadly defined herein to include these tags, maps, labels, packaging, cards, etc.

It should be appreciated that while FIG. 1 illustrates a particular species of ID document—a driver's license—the present invention is not so limited. Indeed our inventive methods and techniques apply generally to all identification documents defined above. Moreover, our techniques are applicable to non-ID documents, e.g., such as printing or forming covert images on physical objects, holograms, etc., etc. Further, instead of ID documents, the inventive techniques can be employed with product tags, product packaging, business cards, bags, charts, maps, labels, etc., etc., particularly those items including providing a non-visible indicia, such as an image information on an over-laminate structure. The term ID document is broadly defined herein to include these tags, labels, packaging, cards, etc. In addition, while some of the examples above are disclosed with specific core components, it is noted that-laminates can be sensitized for use with other core components. For example, it is contemplated that aspects of the invention may have applicability for articles and devices such as compact disks, consumer products, knobs, keyboards, electronic components, decorative or ornamental articles, promotional items, currency, bank notes, checks, etc., or any other suitable items or articles that may record information, images, and/or other data, which may be associated with a function and/or an object or other entity to be identified.

It should be understood that various printing processes can be used to create the identification documents described in this document. It will be appreciated by those of ordinary skill in the art that several print technologies including but not limited to indigo (variable offset) laser xerography (variable printing), offset printing (fixed printing), inkjet (variable printing), dye infusion, mass-transfer, wax transfer, variable dot transfer can be used to print variable and/or fixed information one or more layers of the document. The information can be printed using dots, lines or other structures of varying colors to form text or images. The information also can comprise process colors, spot or pantone colors.

It should be appreciated that the methods described above or in the incorporated documents with respect to processing data stored in machine readable devices in the document can be carried out on a general-purpose computer. These methods can, of course, be implemented using software, hardware, or a combination of hardware and software. Systems and methods in accordance with the invention can be implemented using any type of general purpose computer system, such as a personal computer (PC), laptop computer, server, workstation, personal digital assistant (PDA), mobile communications device, interconnected group of general purpose computers, and the like, running any one of a variety of operating systems. We note that some image-handling software, such as Adobe's PrintShop, as well as image-adaptive software such as LEADTOOLS (which provide a library of image-processing functions and which is available from LEAD Technologies, Inc., of Charlotte, N.C.) can be used to facilitate these methods, including steps such as providing enhanced contrast, converting from a color image to a monochromatic image, thickening of an edge, dithering, registration, etc. An edge-detection algorithm may also be incorporated with, or used in concert with, such software. Computer executable software embodying these software methods, functions or routines can be stored on a computer readable media, such as a diskette, removable media, DVD, CD, hard drive, electronic memory circuit, etc.).

It should be understood that, in the Figures of this application, in some instances, a plurality of system elements or method steps may be shown as illustrative of a particular system element, and a single system element or method step may be shown as illustrative of a plurality of a particular systems elements or method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the total number of elements or steps shown for a particular system element or method is not intended to be limiting; those skilled in the art will recognize that the number of a particular system element or method steps can, in some instances, be selected to accommodate the particular user needs.

To provide a comprehensive disclosure without unduly lengthening the specification, applicants hereby incorporate by reference each of the U.S. patent documents referenced above.

The technology and solutions disclosed herein have made use of elements and techniques known from the cited documents. Other elements and techniques from the cited documents can similarly be combined to yield further implementations within the scope of the present invention. Thus, for example, single-bit watermarking can be substituted for multi-bit watermarking, technology described as using imperceptible watermarks or encoding can alternatively be practiced using visible watermarks (glyphs, etc.) or other encoding, local scaling of watermark energy can be provided to enhance watermark signal-to-noise ratio without increasing human perceptibility, various filtering operations can be employed to serve the functions explained in the prior art, watermarks can include subliminal graticules to aid in image re-registration, encoding may proceed at the granularity of a single pixel (or DCT coefficient), or may similarly treat adjoining groups of pixels (or DCT coefficients), the encoding can be optimized to withstand expected forms of content corruption, etc.

Thus, the exemplary embodiments are only selected samples of the solutions available by combining the teachings referenced above. The other solutions necessarily are not exhaustively described herein, but are fairly within the understanding of an artisan given the foregoing disclosure and familiarity with the cited art. The particular combinations of elements and features in the above-detailed embodiments are exemplary only; the interchanging and substitution of these teachings with other teachings in this and the incorporated-by-reference patent documents are also expressly contemplated.

In describing the embodiments of the invention illustrated in the figures, specific terminology is used for the sake of clarity. However, the invention is not limited to the specific terms so selected, and each specific term at least includes all technical and functional equivalents that operate in a similar manner to accomplish a similar purpose.

1. An identification document comprising:
a first layer;
a second layer cut to form a well;
an optical recording media fit into the well; and
a core layer, wherein the first, second and third layers are joined together, the second layer being positioned in between the first and core layers such that the optical media is incorporated in the identification document between the first and core layers.

2. The identification document of claim 1 wherein the first, second and optical recording media are joined together in a composite structure before the composite structure is joined to the core layer.

3. A method for making a web for constructing identification documents, the method comprising:
providing first and second web layers;
cutting the second web layer to form wells for receiving patches of optical recording media;
joining the first and second web layers; and
placing the patches of optical recording media into the wells of the second layer in the joined first and second layers, wherein the first and second layers and patches are combined to form a composite web structure.

4. The method of claim 3 wherein the composite web structure is joined with a core layer to form a web of identification document material.

5. The method of claim 4 wherein the core is printed with information.

6. The method of claim 5 wherein the information includes variable information associated with a bearer of an identification document.

7. A composite web structure comprising:
a first layer;
a second layer cut to form wells;
patches of an optical recording media fit into the wells; wherein the first and second layers are joined together, and the patches are fixed into the wells to form a web laminating structure for laminating on a substrate to make objects with optical recording media incorporated in the objects.

8. The composite web structure of claim 7 wherein the patches are fixed in the wells with a curable liquid.

9. The composite web structure of claim 7 wherein the first and second layers are joined with a clear adhesive enabling a clear optical path through the first layer to the optical recording media.
